(19) United States
(12) Patent Application Publication
(10) Pub. No.: US 2019/0328038 A1
(43) Pub. Date: Oct. 31, 2019

(54) HEATING DEVICE

(71) Applicant: Ting-Hui Huang, Hsinchu City (TW)

(72) Inventors: Ting-Hui Huang, Hsinchu City (TW); Chi-Wen Huang, Hsinchu City (TW)

(21) Appl. No.: 16/101,651

(22) Filed: Aug. 13, 2018

(30) Foreign Application Priority Data
Apr. 30, 2018 (TW) 107114679

(51) Int. Cl. A24F 47/00; A24F 13/22

(52) U.S. Cl. CPC A24F 47/008; H05B 3/42; A24F 13/22

(57) ABSTRACT

Provided is a heating device, which has an electric heating tube disposed in a sleeve-type carrier. The electric heating tube has two electrode portions and an opening end exposed from an opening of the carrier. When in use, a cigarette is placed in the carrier with tobacco of the cigarette filling the electric heating tube and encapsulating a periphery of the electric heating tube. As such, the tobacco of the cigarette can be directly and uniformly heated by the electric heating tube so as to achieve the purpose of heating the tobacco at low temperature.

### BACKGROUND

### 1. Technical Field

The present disclosure relates to heating devices, and, more particularly, to a heating device suitable for heating tobacco at low temperature.

### 2. Description of Related Art

Currently, there are mainly three types of smoking devices: electronic cigarettes, non-burning tobacco smoking devices, and a combination thereof.

Generally, an electronic cigarette vaporizes a liquid solution containing nicotine and flavoring through an atomizer to generate an aerosol for the user to inhale, thereby simulating the feeling of tobacco smoking. However, artificial flavoring prevents the user from tasting natural tobacco flavor and harmful ingredients of the artificial flavoring are usually not listed.

A non-burning smoking device generally heats a container or carrier storing an aerosol precursor or a traditional cigarette to generate smoke.

There are two kinds of heating methods. The first heating method uses a heater made of a positive temperature coefficient (PTC) semiconductor heating element or an elongated heater made of wound Ni—Cr electric heating wires to heat the center of the container or the traditional cigarette. Further, heat energy diffuses from the heater at the center toward the wall of the container or cigarette. The second heating method uses a heating tube with the container or cigarette received therein. As such, the heating tube heats the outside of the container or cigarette and heat energy diffuses from the outside toward the inside of the container or cigarette.

However, as the size of the container is reduced to facilitate holding, the battery capacity is also limited. Therefore, the container has following drawbacks:
1. A specially manufactured aerosol precursor is required.
2. The small size of the container results in weak flavor and the limited power capacity cannot ensure continuous smoking or may result in a short smoking time.
3. The aerosol precursor mainly consists of tobacco leave extracts and a variety of curing agents and additives apt to evaporate, and thereof its flavor is significantly different from that of the conventional tobacco leaves.

Further, the conventional heating tube with a cigarette received therein heats the cigarette from the outside thereof. The inner side of the heating tube is not in direct contact with the outer surface of the cigarette so as to facilitate placing or taking of the cigarette. As such, the temperature of the heating tube needs to be increased to above 350° C. As the cigarette is heated at the high temperature, it produces increased concentrations of tar and other substances that are harmful to health. Also, during the high-temperature heating process, the cigarette paper gives off an odor that adversely affects the flavor of smoke.

Furthermore, the conventional PTC heater, as disclosed in CN 103859608 A, is not bendable and has a thick and wide heating sheet. Therefore, specially manufactured tobacco products are needed. To facilitate insertion of the PTC heating sheet into the tobacco products, the tobacco products should have a small length. On the other hand, if a traditional cigarette is used, insertion of the PTC heating sheet into the traditional cigarette is quite difficult and the cigarette paper may be damaged.

Although the combination of the atomizer and non-burning tobacco smoking device, as disclosed in JP 2017-127300A, improves the flavor of smoke, it increases the health risk such as excessive nicotine intake. Also, it may result in high power consumption and reduced smoking times per charge.

Therefore, how to overcome the above-described drawbacks has become critical.

### SUMMARY

In view of the above-described drawbacks, the present disclosure provides a heating device, which comprises: a carrier having a receiving space and an opening communicating with the receiving space; and an electric heating tube disposed in the receiving space, wherein the electric heating tube has two electrode portions and an opening end facing the opening of the carrier.

In an embodiment, the carrier is a sleeve. In another embodiment, the electric heating tube and the carrier are coaxially arranged.

In an embodiment, the electric heating tube is in the shape of an annular cylinder with a conical top, and two gaps are formed in a wall of the electric heating tube to define the two electrode portions. In another embodiment, the electric heating tube is made of a sheet body, with a portion of the sheet body being removed and the remaining portion of the sheet body being bent to integrally form the two electrode portions and the opening end of the electric heating tube.

In an embodiment, the opening end of the electric heating tube is a sharp end.

In an embodiment, the heating device further comprises a base for supporting the carrier. In another embodiment, the base has a recessed portion for receiving the carrier, and a bottom of the recessed portion is provided with an attachment portion, so as to allow the carrier and the electric heating tube to be securely attached thereto. In an embodiment, a gap is formed between the carrier and the base.

In an embodiment, the heating device further comprises an electric controlling component electrically connected to the electric heating tube so as to transmit an electric current to the two electrode portions and heat the electric heating tube.

In an embodiment, the heating device further comprises a sensor for determining the position of the carrier. In another embodiment, the sensor is an acceleration detector or a face proximity detector.

Therefore, the design of the carrier and the electric heating tube according to the present disclosure allows tobacco to be directly and uniformly heated, thereby dispensing with the conventionally specially manufactured cigarettes or aerosol precursor containers. Since the heating device according to the present disclosure heats tobacco at a low temperature, a preferred non-burning tobacco smoking effect is achieved.

### BRIEF DESCRIPTION OF DRAWINGS

FIG. 1 is a schematic side perspective view of a heating device according to the present disclosure;

FIGS. 2A and 2B are schematic perspective views of a carrier of FIG. 1 according to different embodiments of the present disclosure;

FIG. 3A is a schematic front view of an electric heating tube of FIG. 1;

FIG. 3B is a schematic rear view of the electric heating tube of FIG. 1;

FIGS. 4A to 4G are schematic partial upper views of a slant opening of the electric heating tube of FIG. 3A according to different embodiments of the present disclosure;

FIG. 5A is a schematic side perspective view of the heating device in use according to the present disclosure;

FIG. 5B is a schematically partially cross-sectional upper view of FIG. 5A; and

FIGS. 6A and 6B are schematic side perspective views of heating devices according to other embodiments of the present disclosure.

### DETAILED DESCRIPTION OF PREFERRED EMBODIMENTS

The following illustrative embodiments are provided to illustrate the disclosure of the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “on”, “a” etc. are merely for illustrative purposes and should not be construed to limit the scope of the present disclosure.

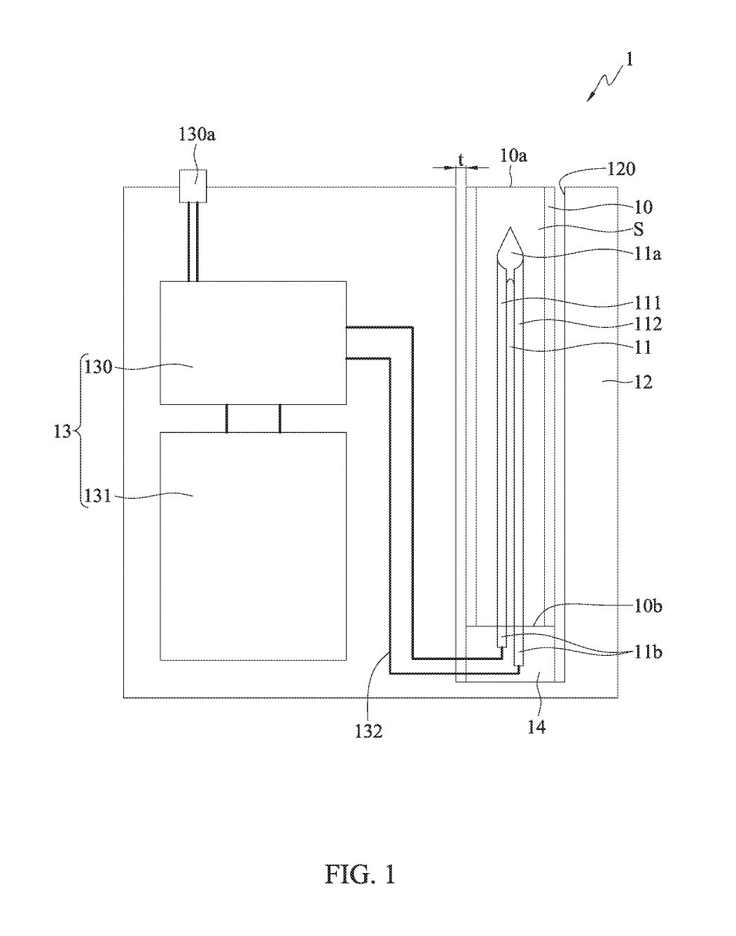

FIG. 1 is a schematic side perspective view of a heating device 1 according to the present disclosure. As shown in FIG. 1, the heating device 1 is used as a non-burning tobacco smoking device, and has a carrier 10, an electric heating tube 11, a base 12 and an electric controlling component 13.

The carrier 10 has a receiving space S and an opening 10a communicating with the receiving space S.

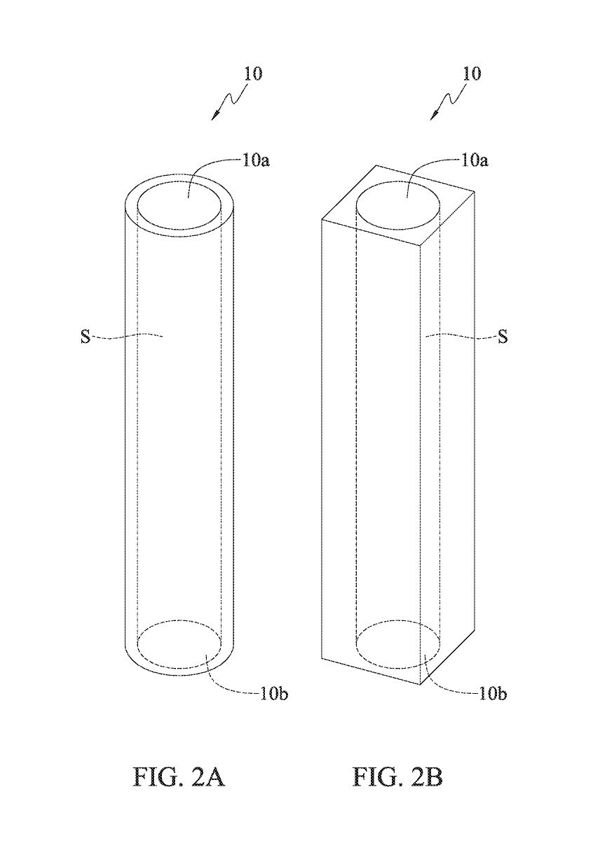

In an embodiment, the carrier 10 is a sleeve made of metal, alloy or ceramic and is cylindrical (as shown in FIG. 2A) or rectangular (as shown in FIG. 2B).

In an embodiment, the receiving space S is a cylindrical channel for receiving a general cigarette. For example, the receiving space S communicates with two ends of the carrier 10, an opening 10a is formed at one end of the carrier 10 and a connection portion 10b is formed at the other end of the carrier 10.

The electric heating tube 11 is coaxially arranged in the receiving space S. The electric heating tube 11 has two electrode portions 111 and 112, connection ends 11b (connection ports of the electrode portions 111 and 112) facing a bottom of the receiving space S (or facing the connection portion 10b), and an opening end 11a facing the opening 10a of the carrier 10. The connection ends 11b can protrude from the connection portion 10b according to the practical need.

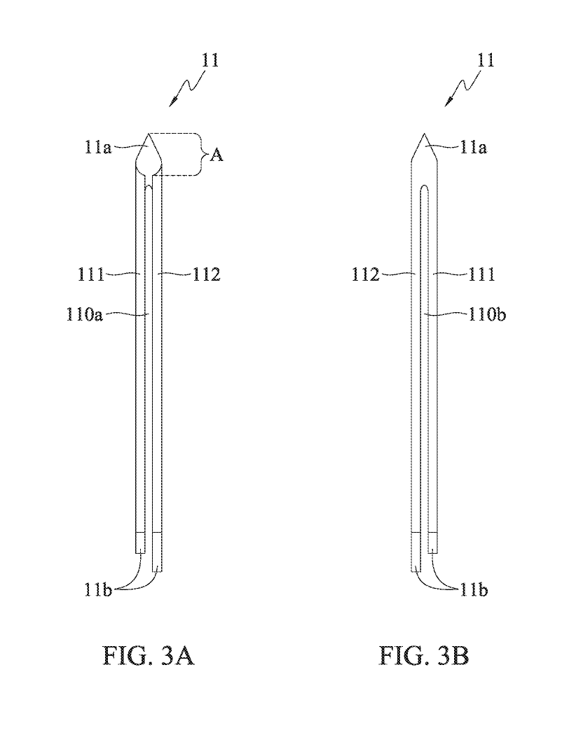

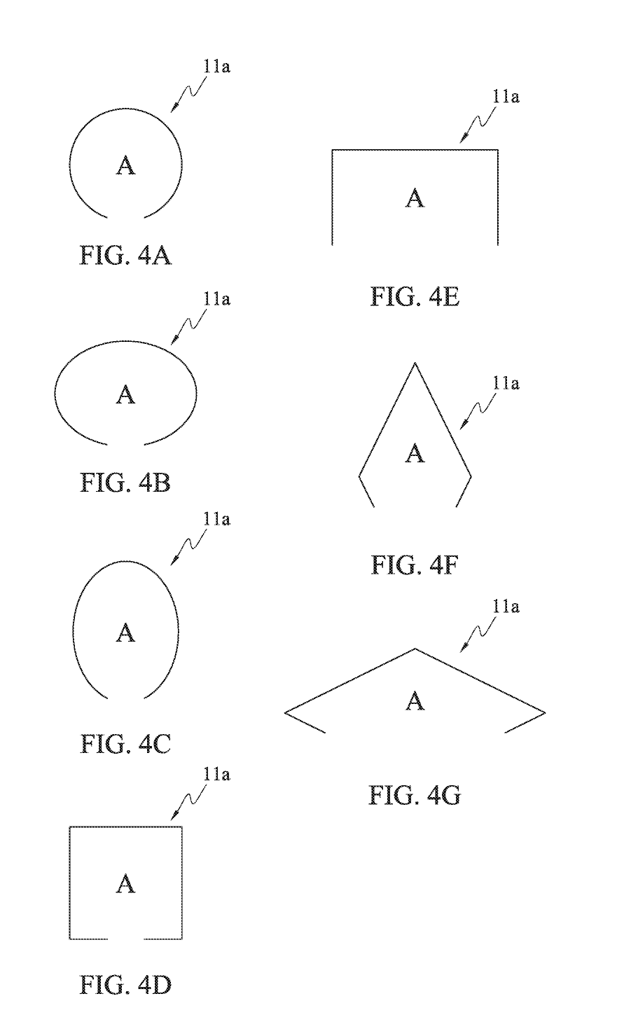

In an embodiment, referring to FIGS. 3A and 3B, the electric heating tube 11 is in the shape of an annular cylinder with a conical top (not closed). Two gaps 110a and 110b are formed in front and rear walls of the electric heating tube 11 to define the two electrode portions 111 and 112 around a periphery of the electric heating tube 11. In another embodiment, the two gaps 110a and 110b extend from top to bottom. The gap 110a communicates with the opening end 11a of the electric heating tube 11, but the gap 110b does not communicate with the opening end 11a of the electric heating tube 11. As such, the opening end 11a connects the two electrode portions 111 and 112. Compared with the gap 110a in the front wall of the electric heating tube 11, the gap 110b in the rear wall surface of the electric heating tube 11 is farther away from the opening end 11a. As such, the two electrode portions 111 and 112 allow an electric current to flow through the whole electric heating tube 11, thereby heating the electric heating tube 11.

The electric heating tube 11 is made of an electric heating conductor with a high resistance, for example, an alloy (not a semiconductor material) such as a Ni—Cr alloy, a Fe—Cr—Al alloy or a stainless steel alloy. Further, other trace metals may be added to prevent corrosion or facilitate processing.

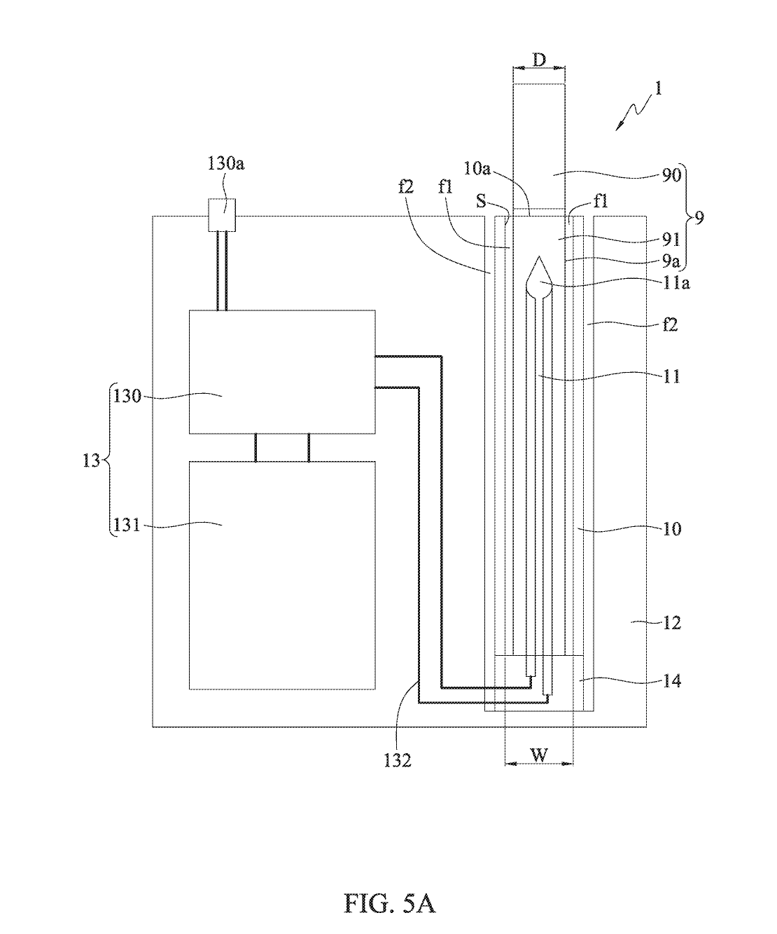

In an embodiment, the opening end 11a is a sharp end in the shape of, for example, an arrow with a slant opening A. Referring to FIGS. 4A, 4B and 4C, if viewed from top, the slant opening A has an arc shape. Alternatively, the slant opening A has a geometrical shape with right angles, as shown in FIGS. 4D and 4E, or a geometrical shape with non-right angles, as shown in FIGS. 4F to 4G.

In an embodiment, the electric heating tube 11 can be made of a sheet body. A portion of the sheet body is removed and the remaining portion of the sheet body is bent to integrally form the two electrode portions 111 and 112 and the opening end 11a of the electric heating tube 11.

The base 12 supports the carrier 10. For example, the base 12 has a recessed portion 120 for receiving the carrier 10.

In an embodiment, referring to FIG. 1, an attachment portion 14 is formed at a bottom of the recessed portion 120 so as to allow the connection portion 10b of the carrier 10 and the connection ends 11b of the electric heating tube 11 to be securely attached thereto. In an embodiment, the attachment portion 14 is made of an insulating and/or high-temperature resistant material (withstand a temperature above 100° C., preferably, above 230° C.). Further, the recessed portion 120 may be in the shape of a circular through hole that corresponds to the carrier 10, thus allowing the connection portion 10b of the carrier 10 to be secured to the bottom of the recessed portion 120.

In an embodiment, the carrier 10 is coaxially arranged in the recessed portion 120. As such, the recessed portion 120 of the base 12 and the receiving space S of the carrier 10 define a double sleeve structure.

The electric controlling component 13 is electrically connected to the electric heating tube 11. In an embodiment, the electric controlling component 13 has a controller 130 with a controlling switch 130a and a power source 131 for supplying power to the controller 130.

In an embodiment, the electric controlling component 13 is embedded in the base 12. The base 12 can be viewed as a housing. The controlling switch 130a is exposed from the base 12.

In an embodiment, the controller 130 is used to control energy level, timing and pulse. By controlling the timing, pulse frequency, electric current or voltage level, the controller 130 controls the energy required by the electric heating tube 11.

The power source 131 is a rechargeable battery for supplying power needed by the electric heating tube 11 and the controller 130.

Electric wires 132 of the electric controlling component 13 pass through the power source 131, the controller 130, the base 12 and the attachment portion 14 to connect with the connection ends 11b (or the connection ports of the electrode portions 111, 112). The attachment portion 14 can be viewed as an adapter or jack.

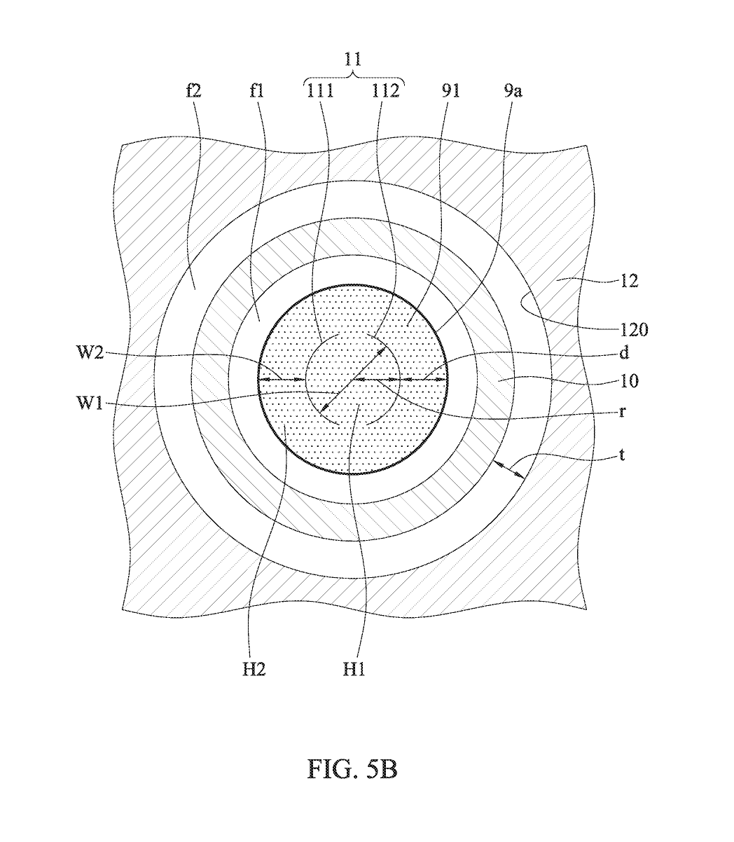

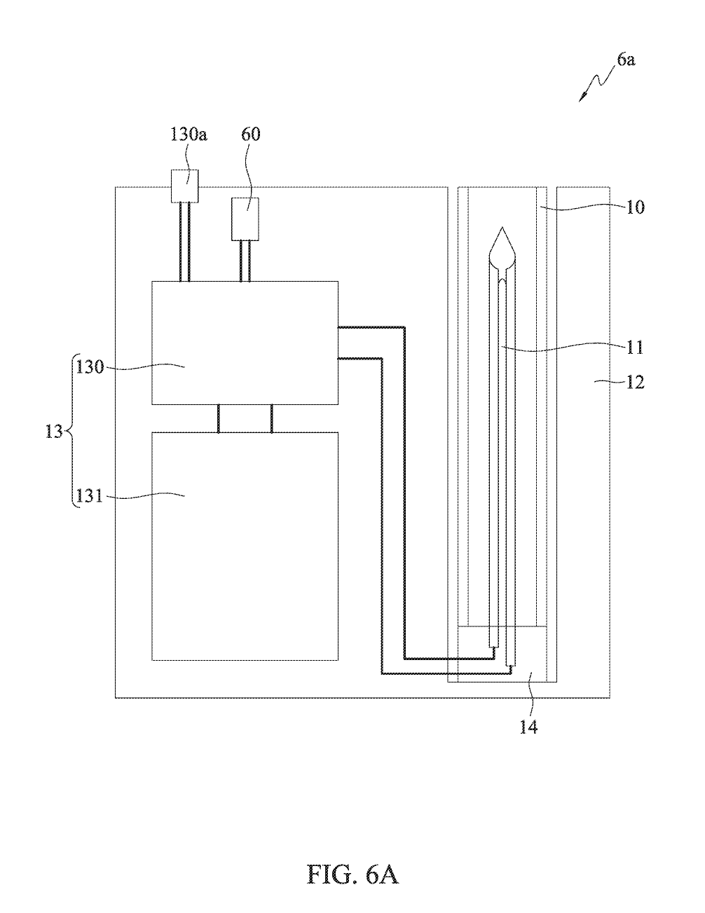

In use, referring to FIGS. 5A and 5B, a traditional cigarette 9 with a filter 90 is inserted into the receiving space S of the carrier 10 and the filter 90 of the cigarette 9 protrudes from the opening 10a of the carrier 10. The controller 130 is turned on by the controlling switch 130a to transmit electric current to the electric heating tube 11. As such, tobacco 91 of the cigarette 9 is directly heated by the electric heating tube 11, and nicotine and other substances produced by the tobacco 91 will not leak out from a paper tube 9a of the cigarette 9. The user can smoke through the filter 90 of the cigarette 9.

According to the present disclosure, the electric heating tube 11 is disposed in the receiving space S, a portion of the tobacco 91 of the cigarette 9 fills the electric heating tube 11 so as to be encapsulated by the electric heating tube 11 and another portion of the tobacco 91 encapsulates a periphery of the electric heating tube 11. As such, the tobacco 91 is directly heated by the electric heating tube 11 instead of being indirectly heated through the cigarette paper tube as in the prior art. Therefore, the present disclosure increases the contact area between the electric heating tube 11 and the tobacco 91 and shortens the heat transfer distance therebetween (referring to FIG. 5B, the distance d between the periphery of the electric heating tube 11 and the paper tube 9a is substantially equal to the radius r of the electric heating tube 11), thereby achieving the purpose of low-temperature heating of the tobacco 91 (between 160° C. and 230° C., preferably between 200° C. and 230° C.), reducing the power consumption and increasing the smoking times per charge.

The low-temperature heating means that the tobacco 91 can be effectively heated for smoke at a heating temperature lower than 230° C. In an embodiment, the traditional cigarette 9 usually contains aqueous potassium citrate crystalline powder, which is used as a combustion improver and has a boiling point of about 230° C. If the heating temperature is above 230° C., the combustion improver will vaporize, thus changing the cigarette flavor. Therefore, it is very important to control the heating temperature below 230° C.

The design of the opening end 11a of the electric heating tube 11 facilitates the insertion of the electric heating tube 11 into the tobacco 91 of the cigarette 9 and allows the tobacco 91 to be filled in the electric heating tube 11 through the slant opening A.

Furthermore, referring to FIG. 5B, since the tobacco 91 of the cigarette 9 is filled in the electric heating tube 11 and encapsulates the periphery of the electric heating tube 11, when the tobacco 91 is heated, an inner heating area H1 and an outer heating area H2 are defined. Half of the width W1 of the inner heating area H1 is substantially equal to the width W2 of the outer heating area H2. That is, ½W1=W2. Therefore, the tobacco 91 is low-temperature heated by the electric heating tube 11 uniformly in all directions. Further, since the receiving space S and the electric heating tube 11 are coaxially arranged, the width W1 of the inner heating area H1 and the width W2 of the outer heating area H2 can be conveniently controlled so as to minimize the heat transfer distance when the tobacco 91 is heated by the electric heating tube 11, thereby meeting the requirements of high efficiency and low power consumption.

Since air is a good heat insulator (having a thermal conductivity of about 0.025 Wm⁻¹K⁻¹), the width W of the receiving space S can be greater than the width D of the cigarette 9 (as shown in FIG. 5A) so as to form a space between the carrier 10 and the paper tube 91 of the cigarette 9 as an air layer f1. As such, heat energy generated by the electric heating tube 11 will not dissipate. Preferably, a gap t is formed between the carrier 10 and the wall of the recessed portion 120 to serve as another air layer f2. Therefore, the present disclosure achieves a double insulation effect. When the user smokes the cigarette 9, the heating process of the electric heating tube 11 will not cause overheat of the base 12. In addition, a suitable insulation material may be filled in the gap t and the space S according to the practical need. Also, more air layers may be provided for enhancing the heat insulation effect.

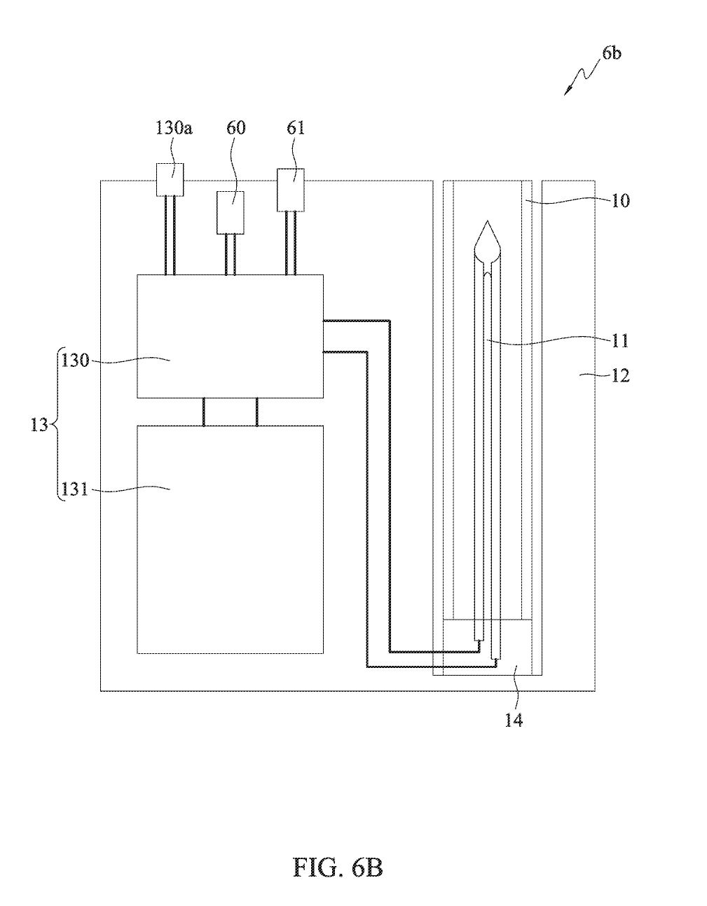

FIGS. 6A and 6B are schematic side perspective views of heating devices 6a and 6b according to other embodiments of the present disclosure.

Referring to FIGS. 6A and 6B, the heating devices 6a and 6b further have at least a sensor 60, 61 for determining position of the carrier 10.

In an embodiment, the sensor 60, 61 is disposed on the base 12 and electrically connected to the controller 130 to form an energy-saving control circuit.

In an embodiment, the sensor 60 is an acceleration detector, and is embedded inside the base 12 and is not exposed from a surface of the base 12.

In an embodiment, when the user holds and moves the base 12 upward (for example, near the mouth) and the sensor 60 detects an upward acceleration, the controller 130 instantly outputs a high heating power to cause the temperature of the heating device 6a to be higher than a predetermined smoke temperature, thereby facilitating the electric heating tube 11 to heat the tobacco. After a period of time, the controller 130 decreases the output power to the heating power for the predetermined smoke temperature.

In another embodiment, when the user stops smoking and moves the base 12 downward (for example, away from the mouth) and the sensor 60 detects a downward acceleration, the controller 130 decreases the output power to a low heating power and the heating device 6a goes into an energy-saving standby state.

Alternatively, another sensor 61 is added to the surface of the base 12, which is a face proximity detector such as an optical transceiver sensitive detector, a pyroelectric infrared radial sensor or an ultrasonic sensitive detector.

In an embodiment, when the user holds and moves the base 12 upward (for example, near the mouth) and the sensor 60 detects an upward acceleration, the controller 130 instantly outputs a high heating power to cause the temperature of the heating device 6b to be higher than a predetermined smoke temperature, thereby facilitating the electric heating tube 11 to heat the tobacco. If the sensor 61 also detects that the face is proximate to the base 12, after outputting the high heating power for a period of time, the controller 130 decreases the output power to the heating power for the predetermined smoke temperature.

If the sensor 60 detects an upward acceleration while the sensor 61 does not detect that the face is proximate to the base 12, the controller 130 will stop the high heating power output and decrease the output power below the heating power for the predetermined smoke temperature, thus causing the heating device 6b to go into an energy-saving standby state.

In another embodiment, when the user stops smoking and moves the base 12 downward, if the sensor 60 detects a downward acceleration (or the sensor 61 does not detect the face), the controller 130 decreases the output power to a low heating power and the heating device 6b goes into the energy-saving standby state.

Therefore, the design of the carrier and the electric heating tube of the present disclosure allows the tobacco of the cigarette to be directly and uniformly heated, thereby dispensing with the conventional specially manufactured cigarettes or aerosol precursor containers. Since the heating device of the present disclosure heats the tobacco at a low temperature, a preferred non-burning tobacco smoking effect is achieved. Further, nicotine and other substances produced by the tobacco do not leak out from the paper tube of the cigarette, thus reducing the amount of secondhand smoke inhaled by others.

Further, since the heating device heats tobacco at a low temperature, the power efficiency is improved. Compared with the prior art, the present disclosure facilitates continuous tobacco smoking or increases the smoking time.

The above-described descriptions of the detailed embodiments are only to illustrate the preferred implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. A heating device, comprising:
a carrier having a receiving space and an opening communicating with the receiving space; and
an electric heating tube disposed in the receiving space and having two electrode portions and an opening end facing the opening of the carrier.

2. The heating device of claim 1, wherein the carrier is a sleeve.

3. The heating device of claim 1, wherein the electric heating tube and the carrier are coaxially arranged.

4. The heating device of claim 1, wherein the electric heating tube is made of a sheet body, with a portion of the sheet body being removed and a remaining portion of the sheet body being bent to integrally form the two electrode portions and the opening end of the electric heating tube.

5. The heating device of claim 1, wherein the electric heating tube is in a shape of an annular cylinder with a conical top.

6. The heating device of claim 1, wherein the electric heating tube has two gaps formed in a wall of the electric heating tube to define the two electrode portions.

7. The heating device of claim 1, wherein the opening end of the electric heating tube is a sharp end.

8. The heating device of claim 1, further comprising a base configured for supporting the carrier.

9. The heating device of claim 8, wherein the base has a recessed portion configured for receiving the carrier.

10. The heating device of claim 9, wherein the recessed portion is provided with an attachment portion at a bottom of the recessed portion.

11. The heating device of claim 10, wherein the carrier and the electric heating tube are securely attached to the attachment portion.

12. The heating device of claim 8, wherein the carrier and the base have a gap formed therebetween.

13. The heating device of claim 1, further comprising an electric controlling component electrically connected to the electric heating tube to transmit an electric current to the two electrode portions and heat the electric heating tube.

14. The heating device of claim 1, further comprising a sensor configured for determining a position of the carrier.

15. The heating device of claim 14, wherein the sensor is an acceleration detector or a face proximity detector.
